(19) United States
(12) Patent Application Publication
(10) Pub. No.: US 2016/0073445 A1
(43) Pub. Date: Mar. 10, 2016

(54) METHOD AND APPARATUS FOR PERFORMING FORWARD LINK DISCONTINUOUS RECEPTION IN CDMA2000 1X/1X ADVANCED NETWORK

(71) Applicant: QUALCOMM Incorporated, San Diego, CA (US)

(72) Inventors: Huang Lou, San Diego, CA (US); Rashid Ahmed Akbar Attar, San Diego, CA (US); Jun Hu, San Diego, CA (US)

(21) Appl. No.: 14/623,944

(22) Filed: Feb. 17, 2015

Related U.S. Application Data
(60) Provisional application No. 62/047,199, filed on Sep. 8, 2014.

(51) Int. Cl. H04W 76/04; H04W 52/44

(52) U.S. Cl. CPC H04W 76/048; H04W 52/44

(57) ABSTRACT

Aspects of the present disclosure provides an apparatus configured to perform discontinuous reception (DRX) in a wireless communications system. The apparatus is configured to receive a forward link (FL) transmission from a network. The FL transmission includes one or more frames, wherein each of the frames includes a plurality of power control groups (PCGs). The apparatus determines a FL setpoint. If the FL setpoint is less than a maximum setpoint value by an amount greater than a predetermined value, the apparatus autonomously enables DRX to receive a predetermined subset of PCGs among the plurality of PCGs.

### CROSS-REFERENCE TO RELATED APPLICATIONS

This application claims priority to and the benefit of provisional patent application No. 62/047,199 filed in the United States Patent and Trademark Office on 8 Sep. 2014, the entire content of which is incorporated herein by reference.

### TECHNICAL FIELD

Aspects of the present disclosure relate generally to wireless communication systems, and more particularly, to methods and an apparatus for performing discontinuous reception (DRX) in a wireless communications system.

### BACKGROUND

Wireless communication systems are widely deployed to provide various communication services such as telephony, video, data, messaging, broadcasts, and so on. Wireless communications networks, which are usually multiple access networks, support communications for multiple users by sharing the available network resources. Examples of such networks include networks based on the Global System for Mobile Communications (GSM), the Universal Mobile Telecommunications System (UMTS), and Long Term Evolution (LTE), which are defined by the Third Generation Partnership Project (3GPP), as well as CDMA2000 1×, 1× Advanced, and EV-DO, which are defined by the Third Generation Partnership Project 2 (3GPP2), among others. Multiple types of devices are adapted to utilize such wireless communications systems. Such devices may be generally referred to as access terminals (ATs). Access terminals are typically powered by a limited power source (e.g., rechargeable battery). Therefore, reducing the power consumption of an AT can result in lower battery requirements and/or longer operating time between charging.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one aspect, the disclosure provides a method of controlling discontinuous reception (DRX) at an access terminal (AT). The AT receives a forward link (FL) transmission including one or more frames, wherein each of the frames includes a plurality of power control groups (PCGs). The AT determines a FL setpoint. If the FL setpoint is less than a maximum setpoint value by an amount greater than a predetermined value, the AT autonomously enables DRX to receive a predetermined subset of PCGs among the plurality of PCGs.

Another aspect of the disclosure provides an access terminal (AT) for wireless communication. The AT includes means for receiving a forward link (FL) transmission including one or more frames, wherein each of the frames includes a plurality of power control groups (PCGs). The AT further includes means for determining a FL setpoint. The AT further includes means for if the FL setpoint is less than a maximum setpoint value by an amount greater than a predetermined value, autonomously enabling discontinuous reception (DRX) to receive a predetermined subset of PCGs among the plurality of PCGs.

Another aspect of the disclosure provides a computer-readable medium including code for causing an access terminal (AT) to perform discontinuous reception (DRX). The code causes the AT to receive a forward link (FL) transmission including one or more frames, wherein each of the frames includes a plurality of power control groups (PCGs). The code causes the AT to determine a FL setpoint. The code further causes the AT to if a FL setpoint is less than a maximum setpoint value by an amount greater than a predetermined value, autonomously enable discontinuous reception (DRX) to receive a predetermined subset of PCGs among the plurality of PCGs.

Another aspect of the disclosure provides an apparatus for wireless communication. The apparatus includes a communication interface configured to receive a forward link (FL) transmission from a network and a computer-readable medium including discontinuous reception (DRX) instructions. The apparatus further includes at least one processor operatively coupled to the communication interface and computer-readable medium. The at least one processor when configured by executing the DRX instructions includes a forward link reception block configured to utilize the communication interface to receive a FL transmission including one or more frames, wherein each of the frames includes a plurality of power control groups (PCGs). The processor further includes a power setpoint block configured to determine a FL setpoint. The processor further includes a discontinuous reception (DRX) control block configured to if the FL setpoint is less than a maximum setpoint value by an amount greater than a predetermined value, autonomously enable DRX to receive a predetermined subset of PCGs among the plurality of PCGs.

These and other aspects of the disclosure will become more fully understood upon a review of the detailed description, which follows. Other aspects, features, and embodiments of the present disclosure will become apparent to those of ordinary skill in the art, upon reviewing the following description of specific, exemplary embodiments of the present disclosure in conjunction with the accompanying figures. While features of the present disclosure may be discussed relative to certain embodiments and figures below, all embodiments of the present disclosure can include one or more of the advantageous features discussed herein. In other words, while one or more embodiments may be discussed as having certain advantageous features, one or more of such features may also be used in accordance with the various embodiments of the disclosure discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a block diagram illustrating an example of a network environment in which one or more aspects of the present disclosure may find application.

FIG. 2 is a diagram illustrating an example of a radio protocol architecture for the user and control plane in accordance with an aspect of the disclosure.

FIG. 3 is a diagram illustrating different access terminal operating states and state transitions in accordance with an aspect of the disclosure.

FIG. 4 is a block diagram illustrating an example of a hardware implementation for an apparatus employing a processing system in accordance with an aspect of the disclosure.

FIG. 5 is a block diagram illustrating a processor and receiver paths of an apparatus in accordance with an aspect of the disclosure.

FIG. 6 is a diagram illustrating a forward link frame structure including sixteen power control groups in accordance with an aspect of the disclosure.

FIG. 7 is a graph illustrating an example of forward setpoint value for controlling autonomously DRX at an access terminal in accordance with an aspect of the disclosure.

FIG. 8 is a diagram illustrating discontinuous reception (DRX) on and off periods in accordance with an aspect of the disclosure.

FIG. 9 is a flow chart illustrating a method of determining a forward link setpoint in accordance with an aspect of the disclosure.

FIG. 10 is a flow chart illustrating a forward link DRX method operable at an access terminal in accordance with aspects of the disclosure.

FIG. 11 is a flow chart illustrating an autonomous DRX method operable at an access terminal in accordance with an aspect of the disclosure.

FIG. 12 is a flow chart illustrating an RxD control method operable at an access terminal in accordance with an aspect of the disclosure.

FIG. 13 is a flow chart illustrating a receiver path blanking method for an early terminated frame in accordance with an aspect of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Various aspects of the present disclosure provide an access terminal (AT) with a device-only (autonomous) discontinuous reception (DRX) capability. Such AT can autonomously enable or disable DRX while in a connected mode without network side support or coordination. The AT can provide good voice quality and/or data throughput, while improving power efficiency using device-only DRX in a connected mode. The device-only DRX techniques of the present disclosure can achieve substantial power savings at the AT. When device-only (autonomous) DRX is enabled while an AT is in a connected mode, the AT may shut down or power off some or all components of a receive (RX) path during certain DRX off periods while receiving a forward link transmission including voice and/or data frames. An RX path may include a number of components and/or circuitry for receiving a forward link transmission from a network. For example, the RX path may include various amplifiers, mixers, converters (e.g., analog-to-digital converters), phase-locked loop (PLL), and other commonly known components used in an RX path, etc. In various aspects of the present disclosure, device-only (autonomous) DRX refers to DRX operations in which an AT can autonomously enable DRX without any coordination with a network. That is, the network may not even be aware that the AT has enabled DRX.

The various concepts presented throughout this disclosure may be implemented across a broad variety of telecommunication systems, network architectures, and communication standards. Certain aspects of the disclosure are described below for CDMA2000 1× and 1× Advanced protocols and systems, and related terminology may be found in much of the following description. However, those of ordinary skill in the art will recognize that one or more aspects of the present disclosure may be employed and included in one or more other wireless communication protocols and systems.

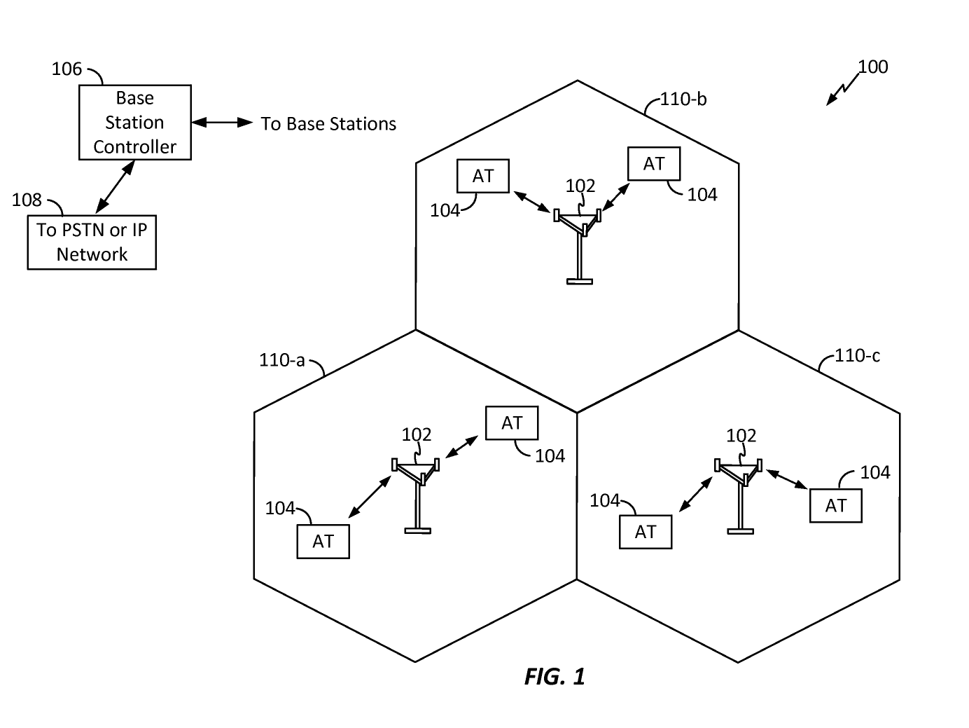

Referring now to FIG. 1, a block diagram is shown illustrating an example of a network environment in which one or more aspects of the present disclosure may find application. A wireless communications system 100 may employ CDMA2000 architecture and/or protocols such as 1× and 1× Advanced (hereinafter generally referred to as 1×). The wireless communication system 100 generally includes one or more base stations 102, one or more access terminals 104, one or more base station controllers (BSC) 106, and a core network 108 providing access to a public switched telephone network (PSTN) (e.g., via a mobile switching center/visitor location register (MSC/VLR)) and/or to an IP network (e.g., via a packet data switching node (PDSN)). The system 100 may support operation on multiple carriers (waveform signals of different frequencies). Multi-carrier transmitters can transmit modulated signals simultaneously on the multiple carriers. Each modulated signal may be a CDMA signal, a TDMA signal, an OFDMA signal, a Single Carrier Frequency Division Multiple Access (SC-FDMA) signal, etc. Each modulated signal may be sent on a different carrier and may carry control information (e.g., pilot signals), overhead information, data, etc.

The base stations 102 can wirelessly communicate with the access terminals 104 via one or more base station antennas. The base stations 102 may each be implemented generally as a device adapted to facilitate wireless connectivity (for one or more access terminals 104) to the wireless communications system 100. A base station 102 may also be referred to by those skilled in the art as an access point, a base transceiver station (BTS), a radio base station, a radio transceiver, a transceiver function, a basic service set (BSS), an extended service set (ESS), a Node B, an eNB, a femto cell, a pico cell, an access point, and/or some other suitable terminology.

The base stations 102 are configured to communicate with the access terminals 104 under the control of the base station controller 106. Each of the base stations 102 can provide communication coverage for a respective geographic area. The coverage area 110 for each base station 102 here is identified as cells 110-a, 110-b, or 110-c. The coverage area 110 for a base station 102 may be divided into sectors (not shown, but making up only a portion of the coverage area). In various examples, the system 100 may include base stations 102 of different types.

One or more access terminals 104 may be dispersed throughout the coverage areas 110. Each access terminal (AT) 104 may communicate with one or more base stations 102. An access terminal 104 may generally include one or more devices that communicate with one or more other devices through wireless signals. Such an access terminal 104 may also be referred to by those skilled in the art as a user equipment (UE), a mobile station (MS), a subscriber station, a mobile unit, a subscriber unit, a wireless unit, a remote unit, a mobile device, a wireless device, a wireless communications device, a remote device, a mobile subscriber station, a mobile terminal, a wireless terminal, a remote terminal, a handset, a terminal, a user agent, a mobile client, a client, or some other suitable terminology. An access terminal 104 may include a mobile terminal and/or at least a substantially fixed terminal Examples of an access terminal 104 include a mobile phone, a pager, a wireless modem, a personal digital assistant, a personal information manager (PIM), a personal media player, a palmtop computer, a laptop computer, a tablet computer, a television, an appliance, an e-reader, a digital video recorder (DVR), a machine-to-machine (M2M) device, a meter, an entertainment device, a toy, automotive/vehicle modules, a sensing device, a wearable computing device (e.g., a smartwatch, a health or fitness tracker), a router, an Internet-of-Things device, and/or other communication/computing device which communicates, at least partially, through a wireless or cellular network.

The AT 104 may be adapted to employ a protocol stack architecture for communicating data between the access terminal 104 and one or more network nodes of the wireless communication system 100 (e.g., the base station 102). A protocol stack generally includes a conceptual model of the layered architecture for communication protocols in which layers are represented in order of their numeric designation, where transferred data is processed sequentially by each layer, in the order of their representation. Graphically, the “stack” is typically shown vertically, with the layer having the lowest numeric designation at the base.

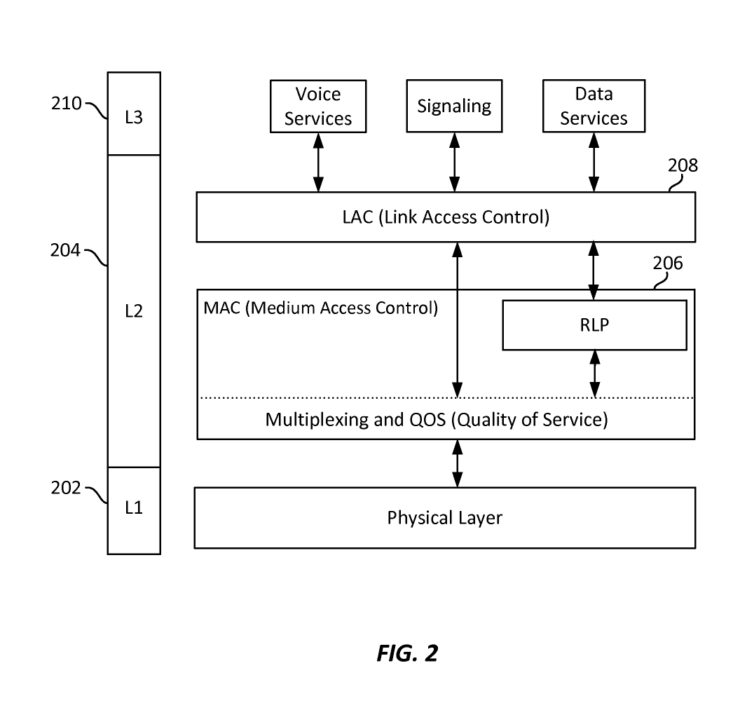

FIG. 2 is a block diagram illustrating an example of a protocol stack architecture which may be implemented by an access terminal 104. Referring to FIGS. 1 and 2, the protocol stack architecture for the access terminal 104 is shown to generally include three layers: layer 1 (L1), layer 2 (L2), and layer 3 (L3). Layer 1 202 is the lowest layer and implements various physical layer signal processing functions. Layer 1 202 is also referred to herein as the physical layer. This physical layer 202 provides for the transmission and reception of radio signals between the access terminal 104 and a base station 102.

The data link layer, called layer 2 (or “the L2 layer”) 204 is above the physical layer 202 and is responsible for delivery of signaling messages generated by L3. The L2 layer 204 makes use of the services provided by the physical layer 202. The L2 layer 204 may include two sublayers: the Medium Access Control (MAC) sublayer 206, and the Link Access Control (LAC) sublayer 208.

The MAC sublayer 206 is the lower sublayer of the L2 layer 204. The MAC sublayer 206 implements the medium access protocol and is responsible for transport of higher layers' protocol data units using the services provided by the physical layer 202. The MAC sublayer 206 may manage the access of data from the higher layers to the shared air interface.

The LAC sublayer 208 is the upper sublayer of the L2 layer 204. The LAC sublayer 208 implements a data link protocol that provides for the correct transport and delivery of signaling messages generated at the layer 3. The LAC sublayer makes use of the services provided by the lower layers (e.g., layer 1 and the MAC sublayer).

Layer 3 210, which may also be referred to as the upper layer or the L3 layer, originates and terminates signaling messages according to the semantics and timing of the communication protocol between a base station 102 and the access terminal 104. The L3 layer 210 makes use of the services provided by the L2 layer. Information (data and/or voice) message are also passed through the L3 layer 210.

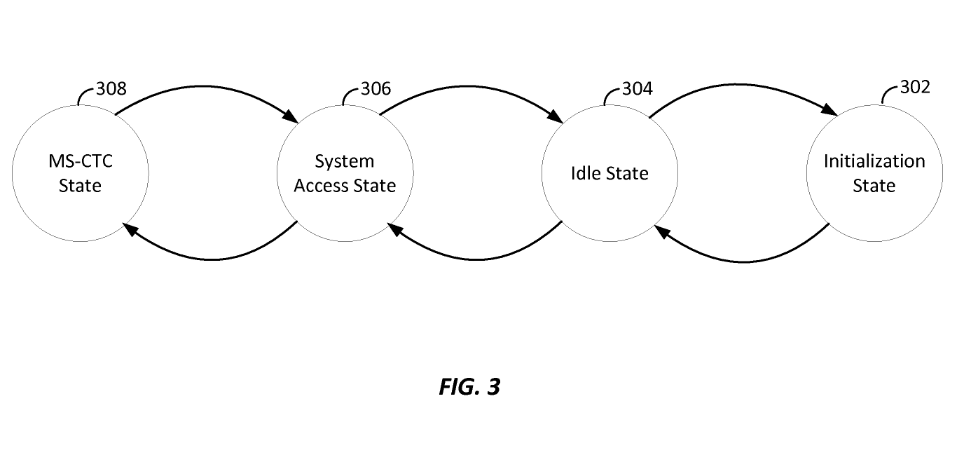

In a CDMA2000 system, an AT may be in one of four different states: (1) mobile station initialization state 302, (2) mobile station idle state 304, (3) system access state 306, and (4) mobile station control on the traffic channel (MS-CTC) state 308. Referring to FIG. 3, in an initialization state 302, the AT selects and acquires a system. After the AT acquires the system, it stays in the idle state 304 and monitors a forward channel, for example, for incoming messages (e.g., paging messages). The AT enters the system access state 306 if the AT receives a message, originates a call, or performs registration. If call origination is successful, the AT is directed to a traffic channel by the base station, in which case the AT enters the MS-CTC state 308. In this state, the AT can communicate with the base station using the traffic channel. In some aspects of the disclosure, device-only (autonomous) DRX may be enabled while an AT is in the system access state 306 and/or MS-CTC state 308. In this specification, the AT is in a connected state when it is in either one of the system access state 306 or MS-CTC state 308.

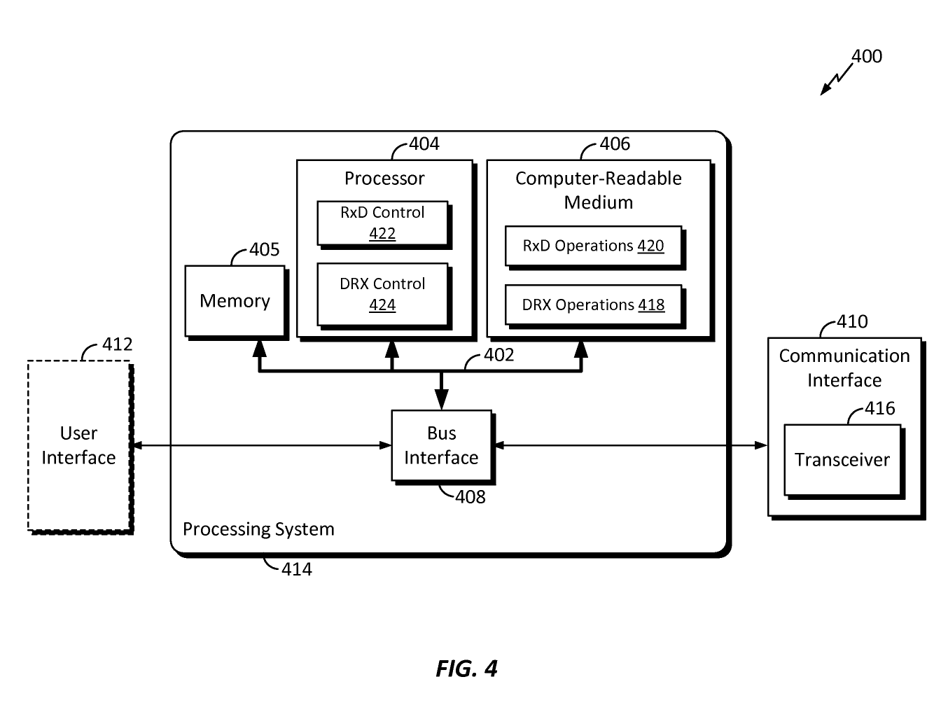

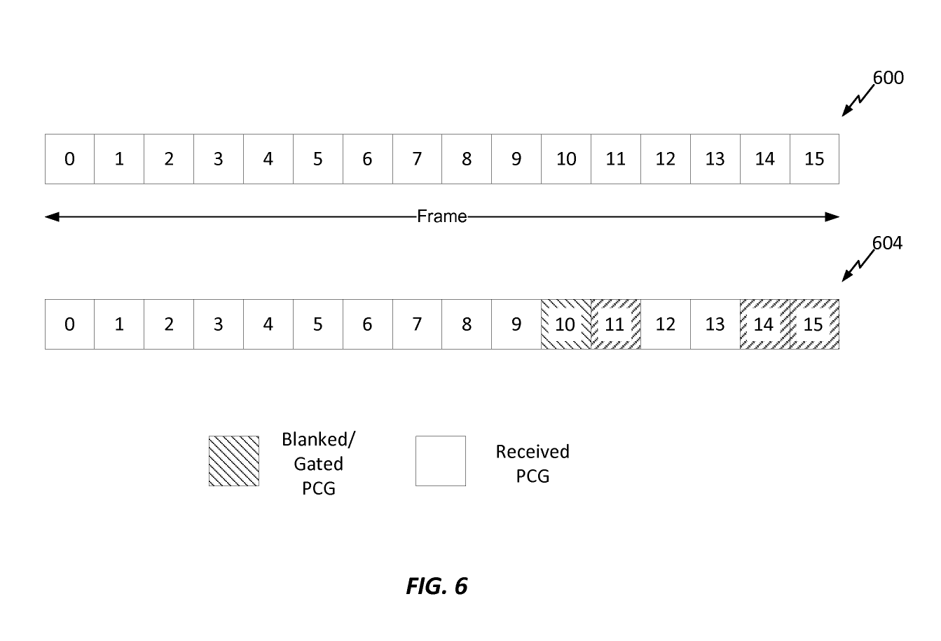

FIG. 4 is a diagram illustrating an example of a hardware implementation for an apparatus 400 employing a processing system 414. In accordance with various aspects of the disclosure, an element, or any portion of an element, or any combination of elements may be implemented with a processing system 414 that includes one or more processors 404. For example, the apparatus 400 may be any of the ATs as illustrated in FIG. 1. Examples of processors 404 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. That is, the processor 404, as utilized in an apparatus 400, may be used to implement any one or more of the processes and functions described below and illustrated in FIGS. 6-13.

In this example, the processing system 414 may be implemented with a bus architecture, represented generally by the bus 402. The bus 402 may include any number of interconnecting buses and bridges depending on the specific application of the processing system 414 and the overall design constraints. The bus 402 links together various circuits including one or more processors (represented generally by the processor 404), a memory 405, and computer-readable media (represented generally by the computer-readable medium 406). The bus 402 may also link various other circuits such as timing sources, peripherals, voltage regulators, and power management circuits, which are well known in the art, and therefore, will not be described any further. A bus interface 408 provides an interface between the bus 402 and a communication interface 410. The communication interface 410 may include a transceiver 416 that provides a means for communicating with various other apparatuses over a transmission medium. For example, the transceiver 416 may include one or more transmitters for transmitting signals and one or more receivers for receiving signals. Depending upon the nature of the apparatus, a user interface 412 (e.g., switches, keypad, display, speaker, microphone, joystick, touchscreen, touchpad, haptic device) may also be provided.

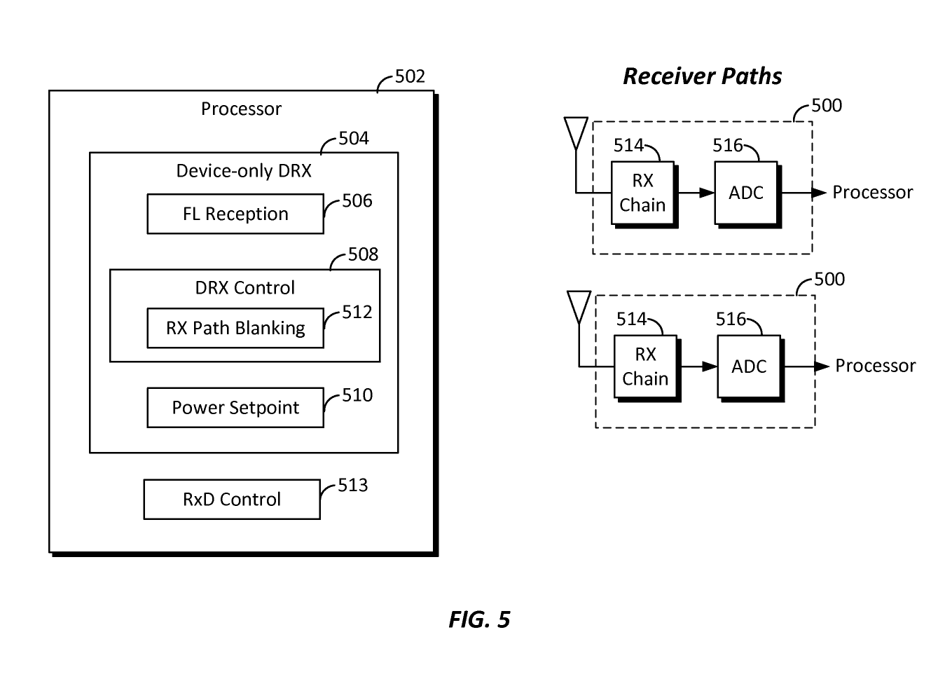

In one aspect of the disclosure, the communication interface 410 may have multiple receiver chains (not shown in FIG. 4) to enhance the received signal. In one example, the apparatus 400 may have two receiver paths 500 (FIG. 5) configured for receive diversity (RxD) operations. For example, during RxD operations, the apparatus 400 may utilize two or more antennas, spatially separated from one another, to receive signals at the same time (combination diversity) or receive signals one antenna at a time (switched diversity). The processor 404 includes an RxD control block 422 that may be configured to perform various receive diversity functions described in FIGS. 6-13. For example, the RxD control block 422 can enable or disable one or more receiver paths 500. When a receiver path 500 is disabled, turned off, or powered down, one or more of its components may be powered down or turned off. The processor 404 also includes a DRX control block 424 that may be configured to perform various DRX functions and processes described below in reference to FIGS. 6-13.

FIG. 5 is a block diagram illustrating a processor 502 and receiver paths 500 of an apparatus in accordance with some aspects of the disclosure. The processor 502 may be the same as the processor 404 of FIG. 4. In this example, the processor 502 includes a device-only DRX block 504 that may be configured to perform a number of device-only (autonomous) DRX operations below and illustrated in FIGS. 6-13 when the processor 502 executes, for example, DRX instructions 418 stored in the computer-readable storage 406. The device-only DRX block 504 may be the same as the DRX control block 424 of FIG. 4. The various blocks and components of the apparatus shown in FIGS. 4 and 5 may be implemented in software, firmware, hardware, or any combinations thereof.

Each receiver path 500 includes a number of components and circuitry that may be partially or completely included in the communication interface 410. The apparatus 400 may include one or more receiver paths 500 to support diversity reception. In the illustrated example, the receiver path 500 includes a receiver (RX) chain 514 and an analog-to-digital converter (ADC) 516, and other commonly known components. Each of the RX chain 514 and ADC 516 may include one or more generally known circuit components. By way of example but not limitation, the RX chain 514 may include one or more of amplifiers (e.g., low noise amplifiers), filters, prescalers, mixers, phase-locked loop, etc.

In one aspect of the disclosure, the device-only DRX block 504 includes a forward link (FL) reception block 506, a discontinuous reception (DRX) control block 508, and a power setpoint block 510. The FL reception block 506 can be configured to perform various functions related to receiving a forward link transmission from a network or base station. The DRX control block 508 can be configured to perform various DRX control functions. For example, the DRX control block 508 may include an RX path blanking block 512 that can be configured to disable, power down, or shut down a receiver path 500 during a device-only (autonomous) DRX off period described below and illustrated in FIGS. 6-13.

The processor 502 also includes a receive diversity (RxD) control block 513 that can be configured to enable or disable receive diversity of the apparatus utilizing the receiver paths 500. The power setpoint block 510 can be configured to determine a current FL setpoint and compare the FL setpoint with various threshold values (e.g., a maximum setpoint value). The FL setpoint corresponds to a power level at which the base station should transmit its information in order to meet a desired target frame error rate (FER). The maximum setpoint value may be a parameter sent by the base station in a control or signaling message.

Referring back to FIG. 4, the processor 404 is also responsible for managing the bus 402 and general processing, including the execution of software stored on the computer-readable medium 406. The software (e.g., DRX instructions 418 and RxD instructions 420), when executed by the processor 404, configure the apparatus 400 including the above described components and blocks of FIGS. 4 and 5, to perform the various functions and processes described below and illustrated in FIGS. 6-13. The computer-readable medium 406 may also be used for storing data that is manipulated by the processor 404 when executing software.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 406 or a suitable storage device inside or outside of the apparatus 400. The computer-readable medium 406 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 406 may reside in the processing system 414, external to the processing system 414, or distributed across multiple entities including the processing system 414. The computer-readable medium 406 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

FIG. 6 is a diagram illustrating a forward link frame 600 including sixteen power control groups (PCGs) in accordance with an aspect of the disclosure. In one example, each 1× voice frame (e.g., 20 millisecond (ms) frame) is organized into 16 time intervals of equal duration. These time intervals, each of 1.25 ms, are called Power Control Groups (PCGs) in the literature (e.g., 1× standards). In some aspects of the disclosure, the frame may have other numbers of PCGs per frame (e.g., 4 or 8 PCGs per 20 millisecond frame). In one aspect of the disclosure, the frame 600 may be a 1X voice frame transmitted to an AT (e.g., AT 400). The PCGs are labeled with index numbers from 0 through 15. In the 1× standards, voice frames have redundancy built in. Therefore, gating some percentage of the 1× voice frames would not substantially impact voice call quality. Here, gating refers to receiving only some (e.g., a subset or a predetermined percentage) of the PCGs in a frame. Gating of a voice frame may be implemented by performing discontinuous reception (DRX) on an RX path (e.g., RX path 500 of FIG. 5) for receiving the voice frames.

Throughout this disclosure, the described DRX operations performed on a FL frame is device-only (autonomous) DRX. Referring to FIG. 6, a frame 604 is an example of a gated 1× voice frame in accordance with an aspect of the disclosure. In this gating example, an AT may select to receive only PCGs 0-9, 12, and 13 (i.e., RX path enabled during these PCGs) while PCGs 10, 11, 14, and 15 are not received (i.e., RX path disabled during these PCGs). Referring to FIG. 8, when DRX is enabled, the RX path is enabled during the DRX on period 802, and disabled or powered down during the DRX off period 804. The specific example shown in FIG. 8 is non-limiting, and the DRX on periods and DRX off periods may have the same or different durations and/or patterns. In other examples, other gating patterns may be used. In one aspect of the disclosure, DRX may be enabled such that the RX path is disabled in about 25 percent of the time used to receive the PCGs (i.e., a frame). In one aspect of the disclosure, a suitable gating pattern allows the AT to receive those PCGs containing Reverse Power Control (RPC) bits. The RPC bits are used to control the power that the AT uses to transmit in the reverse link (RL) direction. In one aspect of the disclosure, DRX may be enabled only when receive diversity (RxD) is turned off.

In one aspect of the disclosure, if a packet is early terminated, the AT may even apply higher percentage of blanking (gating). For example, a 1× Advanced forward link with Radio Configuration (RC) 11 can utilize frame early termination. Frame early termination is a technique for improving capacity at a base station. When a base station transmits a frame on the forward link, if the signal-to-noise ratio (SNR) is sufficiently high, it may be possible for the AT to decode the frame earlier than the end of the frame (i.e., early terminated). That is the AT can decode the frame before receiving the complete frame. Thus, once the AT successfully decodes the frame without receiving the complete frame, it can signal the base station to terminate transmission of the frame earlier than the nominal length of the frame. In this way, the forward link frame transmission is early terminated.

In one aspect of the disclosure, if a frame is early terminated before all PCGs are received, all the remaining PCGs except those carrying power control information (e.g., PCGs 1, 5, 9, 13) can be gated off when DRX is enabled to allow even greater power savings. When DRX is enabled, the RX path including the PLL and ADC can be shut down to save power during the DRX off periods.

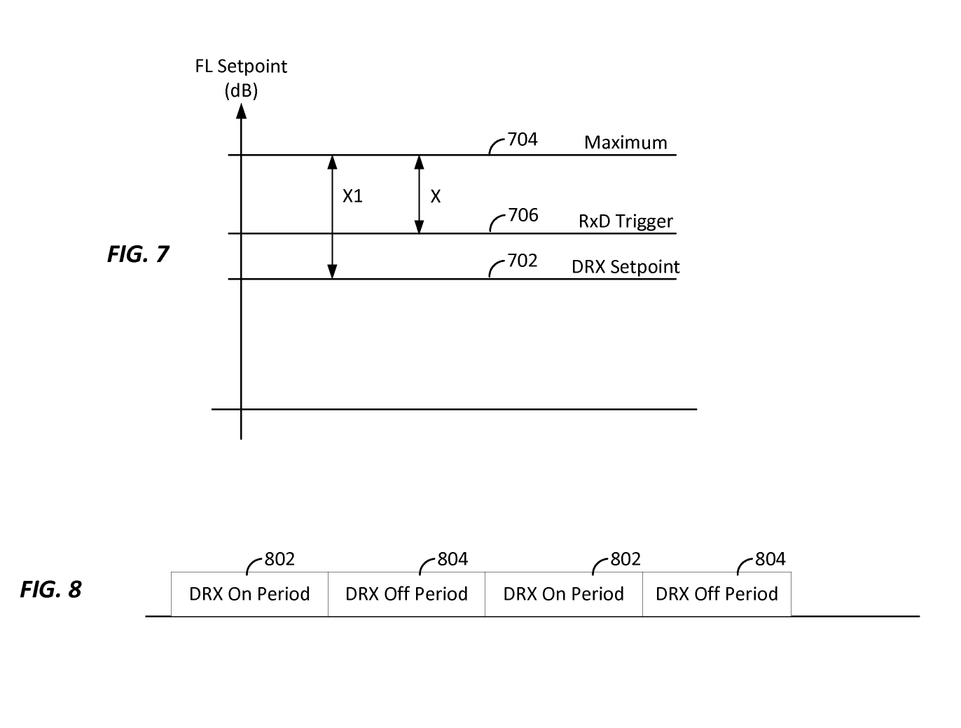

In another aspect of the disclosure, device-only (autonomous) DRX may be enabled when a forward link setpoint is less than a setpoint maximum value by an amount greater than a certain threshold value. FIG. 7 is a graph illustrating an example of a FL setpoint value for autonomously enabling DRX at an AT in accordance with an aspect of the disclosure. In one example, an AT may autonomously enable DRX when the FL setpoint is less than the maximum value 704 by a first amount X1 that is greater than a second amount X (i.e., X1>X). In one non-limiting example, the first amount X1 may be 3 dB, and the second amount X may be 2 dB. However, X and X1 may have any suitable values. In one example, autonomous DRX may be enabled when the FL setpoint is less than the DRX setpoint 702. In one particular example, as long as the FL setpoint is less than the RxD trigger level 706, RxD is not enabled while autonomous DRX is enabled. In one aspect of the disclosure, autonomous DRX may be disabled when the FL setpoint is undesirably close (e.g., less than 1 dB) to the maximum setpoint value 704 in order to protect system performance. In one aspect of the disclosure, autonomous DRX may not be enabled when the FL setpoint is between RxD trigger 706 and DRX setpoint 702.

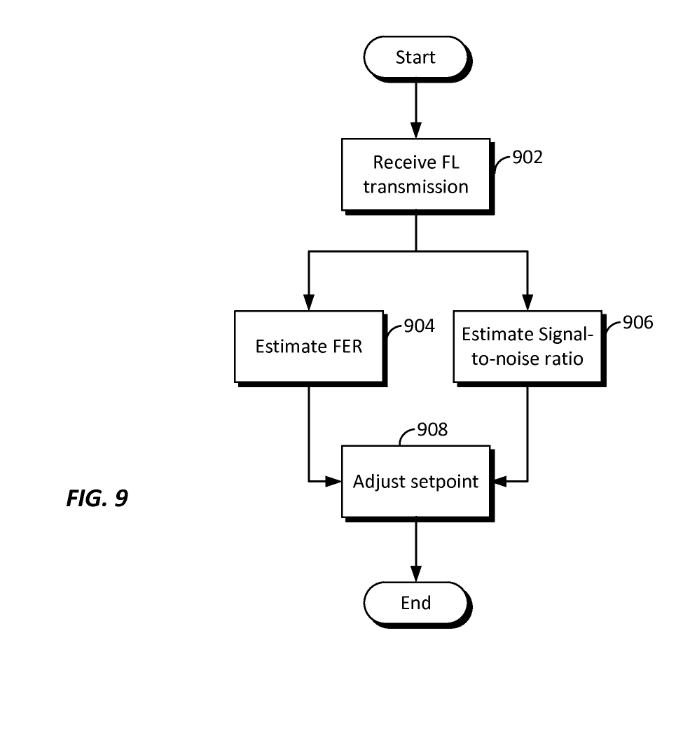

FIG. 9 is a flow chart illustrating a method 900 of determining a forward link (FL) setpoint in accordance with an aspect of the disclosure. The method 900 may be performed by any of the ATs illustrated in FIGS. 1 and/or 4, or any suitable device. At block 902, an AT may utilize a FL reception block 506 to receive a FL transmission from a network or base station. At block 904, the AT may utilize the power setpoint block 510 to estimate a forward link error rate (FER). At block 906, the AT may utilize the power setpoint block 510 to estimate a signal-to-noise ratio (SNR) of the forward link. For example, the SNR may be E_{b}/N₀ (the energy per bit to noise power spectral density ratio) of the forward link. The parameter E_{b}/N₀ is a normalized signal-to-noise ratio measure, also known as the “SNR per bit” in some literature. At block 908, the AT dynamically determines a new setpoint (e.g., E_{b}/N₀) to achieve an acceptable FER, based on the current FER and the estimated SNR. For example, the AT may increase the setpoint to reduce the FER. The procedure described above in reference to FIG. 9 may be utilized in the power control of the AT.

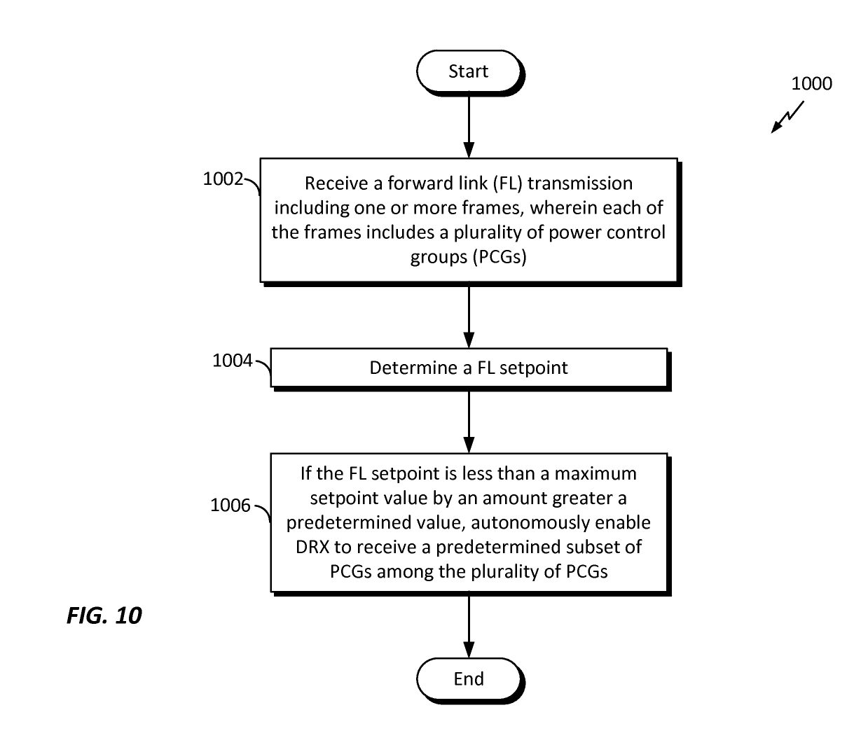

FIG. 10 is a flow chart illustrating a device-only (autonomous) DRX method 1000 operable at an access terminal in accordance with aspects of the disclosure. The method 1000 may be performed by any of the ATs illustrated in FIGS. 1 and/or 4, or any suitable device. In one particular example, the method 1000 may be performed by the AT 400 when executing the DRX instructions 418. At block 1002, the AT receives a forward link (FL) transmission including one or more frames. Each of the frames includes a number of PCGs. For example, the frame may be a 1× voice frame similar to the one illustrated in FIG. 6. In one aspect of the disclosure, the AT may utilize the transceiver 416, the FL reception block 506, and the RF path 500 (see FIG. 5) to receive the FL frames.

At block 1004, the AT may utilize the power setpoint block 510 to determine a current FL setpoint. At block 1006, if the FL setpoint is less than a maximum setpoint value by an amount greater than a predetermined value, the AT autonomously enables discontinuous reception (DRX) to receive a predetermined subset of PCGs among the plurality of PCGs (i.e., not receiving all PCGs of a frame). In one example, the predetermined subset of PCGs may include PCGs 0-9, 12, and 13, but not PCGs 10, 11, 14, and 15. In one aspect of the disclosure, the AT may utilize the DRX control block 508 to autonomously enable DRX in order to receive the subset of PCGs. In some aspects of the disclosure, the AT enables autonomous DRX only if RXD is off. For example, before enabling autonomous DRX, the AT first checks if RXD is off or not. There are various factors (e.g., consecutive frame errors) other than FL setpoint that may trigger RXD.

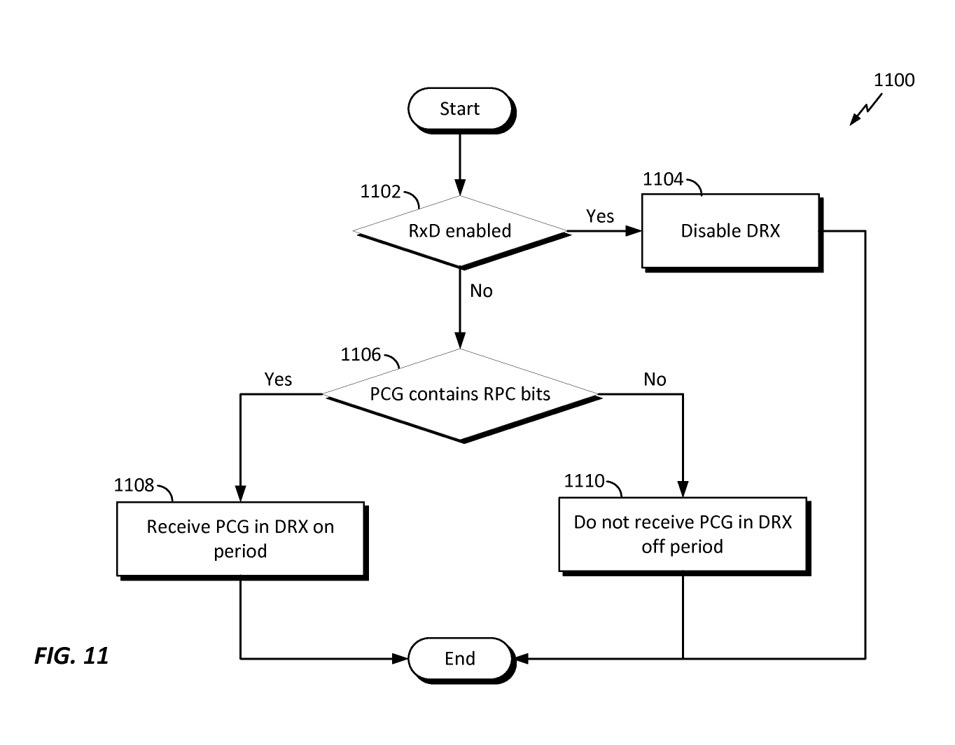

FIG. 11 is a flow chart illustrating an autonomous DRX method 1100 operable at an access terminal in accordance with an aspect of the disclosure. The autonomous DRX method 1100 may be performed by any of the ATs illustrated in FIGS. 1 and/or 4, or any suitable device. In one particular example, the method 1100 may be performed by the AT 400 at block 1006 of FIG. 10 when executing the DRX instructions 418. At decision block 1102, if RxD is enabled at the AT, the method 1100 proceeds to block 1104; otherwise, the method 1100 proceeds to block 1106. At block 1104, the AT may utilize the DRX control block 508 to disable DRX or forgo enabling DRX. At decision block 1106, if a PCG of a frame (e.g., frame 604 of FIG. 6) contains RPC bits, the method 1100 proceeds to block 1108; otherwise, the method 1100 proceeds to block 1110. At block 1108, the AT enables DRX and receives the PCG in a DRX on period. At block 1110, the AT enables DRX but does not receive the PCG in a DRX off period. During the DRX off period, the AT may utilize the RX path blanking block 512 to blank a receiver path 500 such that the AT may save power by powering down one or more components of the receiver path 500.

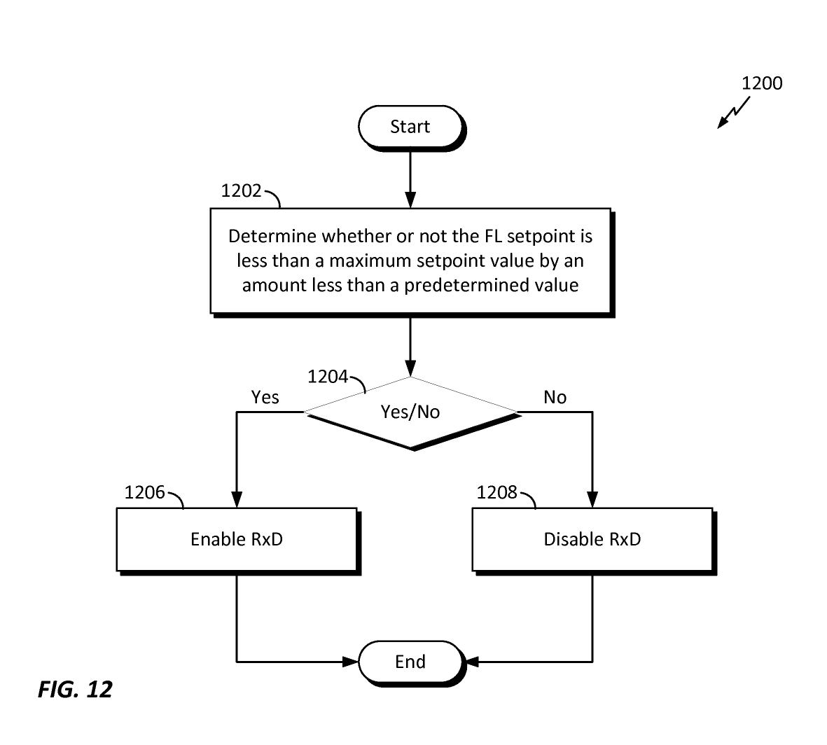

FIG. 12 is a flow chart illustrating an RxD control method 1200 operable at an access terminal in accordance with an aspect of the disclosure. The RxD control method 1200 may be performed by any of the ATs illustrated in FIGS. 1 and/or 4, or any suitable device. In one particular example, the method 1200 may be performed by the AT 400 at block 1006 of FIG. 10 when executing the RxD instructions 420. At block 1202, the AT may utilize the power setpoint block 510 to determine whether or not the FL setpoint is less than a maximum setpoint value by an amount less than a predetermined value. For example, the FL setpoint may be the setpoint 702 of FIG. 7, and the predetermined value may be the difference between the maximum setpoint value 704 and the RxD trigger value 706 in FIG. 7. In other aspects of the disclosure, the predetermined value may be set to any suitable value to avoid triggering RxD at the AT. At decision block 1204, if the FL setpoint is less than the maximum setpoint value by an amount less than the predetermined value, the method 1200 proceeds to block 1206; otherwise, the method 1200 proceeds to block 1208. At block 1206, the AT enables RxD, for example, utilizing two or more of the receiver paths 500 of FIG. 5 for receive diversity. At block 1208, the AT disable RxD. In one aspect of the disclosure, the AT only enable DRX operations when RxD is not enabled.

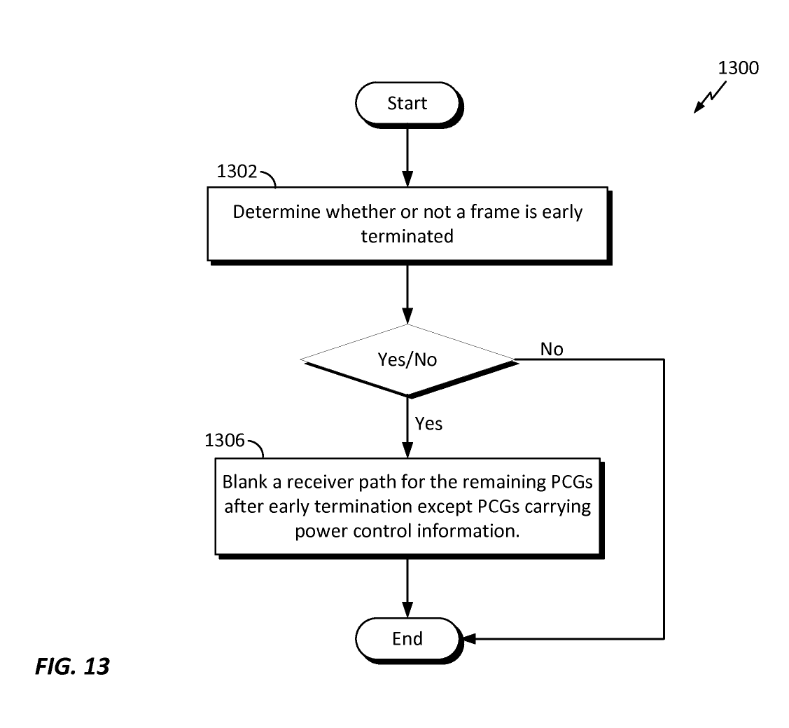

FIG. 13 is a flow chart illustrating a receiver (RX) path blanking method 1300 for an early terminated frame in accordance with an aspect of the disclosure. The RX path blanking method 1300 may be performed by any of the ATs illustrated in FIGS. 1 and/or 4, or any suitable device. In one aspect of the disclosure, the AT may perform the banking method 1300 when autonomous DRX is enabled. In one particular example, the AT may utilize a RX path blanking block 512 to blank a receiver path 500 (FIG. 5) according to the blanking method 1300 while executing the DRX instructions 418. At block 1302, the AT determines whether or not a frame (e.g., a voice frame 600 of FIG. 6) is early terminated. At block 1306, if the frame is early terminated, the AT blanks a receiver path for the remaining PCGs after early termination except those PCGs carrying power control information (e.g., RPC bits). Therefore, the AT may reduce its power consumption by blanking the receiver path after a frame is early terminated.

Several aspects of a telecommunications system have been presented with reference to a CDMA2000 system. As those skilled in the art will readily appreciate, various aspects described throughout this disclosure may be extended to other telecommunication systems, network architectures and communication standards.

By way of example, various aspects may be extended to UMTS systems such as TD-SCDMA and TD-CDMA. Various aspects may also be extended to systems employing Long Term Evolution (LTE) (in FDD, TDD, or both modes), LTE-Advanced (LTE-A) (in FDD, TDD, or both modes), Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of controlling discontinuous reception (DRX) at an access terminal (AT), comprising:
receiving a forward link (FL) transmission comprising one or more frames, wherein each of the frames comprises a plurality of power control groups (PCGs);
determining a FL setpoint; and
if the FL setpoint is less than a maximum setpoint value by an amount greater than a predetermined value, autonomously enabling DRX to receive a predetermined subset of PCGs among the plurality of PCGs.

2. The method of claim 1, wherein the plurality of PCGs comprise PCG 0 through PCG 15 as defined in CDMA2000 1× standards, and the predetermined subset of PCGs comprises at least one of PCG 10, PCG 11, PCG, 14, or PCG 15.

3. The method of claim 1, wherein the autonomously enabling DRX comprises blanking a receiver path for a predetermined percentage of the time utilized to receive the plurality of PCGs.

4. The method of claim 1, further comprising if the FL setpoint is less than the maximum setpoint value by an amount less than the predetermined value, enabling receive diversity.

5. The method of claim 1, further comprising disabling DRX when receive diversity is enabled at the AT.

6. The method of claim 1, wherein the autonomously enabling DRX comprises:
if the frame is early terminated, blanking a receiver path for receiving the remaining PCGs after early termination except the PCGs carrying power control information.

7. The method of claim 6, wherein the blanking the receiver path comprises powering down at least one component of the receiver path during a DRX off period.

8. An access terminal for wireless communication, comprising:
means for receiving a forward link (FL) transmission comprising one or more frames, wherein each of the frames comprises a plurality of power control groups (PCGs);
means for determining a FL setpoint; and
means for if the FL setpoint is less than a maximum setpoint value by an amount greater than a predetermined value, autonomously enabling discontinuous reception (DRX) to receive a predetermined subset of PCGs among the plurality of PCGs.

9. The access terminal of claim 8, wherein the plurality of PCGs comprises PCG 0 through PCG 15 as defined in CDMA2000 1× standards, and the predetermined subset of PCGs comprise at least one of PCG 10, PCG 11, PCG, 14, or PCG 15.

10. The access terminal of claim 8, wherein the means for autonomously enabling DRX is configured to blank a receiver path for a predetermined percentage of the time utilized to receive the plurality of PCGs.

11. The access terminal of claim 8, further comprising means for if the FL setpoint is less than the maximum setpoint value by an amount less than the predetermined value, enabling receive diversity.

12. The access terminal of claim 8, further comprising means for disabling DRX when receive diversity is enabled at the AT.

13. The access terminal of claim 8, wherein the means for autonomously enabling DRX is further configured to:
if the frame is early terminated, blank a receiver path for receiving the remaining PCGs after early termination except the PCGs carrying power control information.

14. The access terminal of claim 13, wherein for blanking the receiver path, the means for autonomously enabling DRX is configured to power down at least one component of the receiver path during a DRX off period.

15. A computer-readable medium comprising code for causing an access terminal (AT) to:
receive a forward link (FL) transmission comprising one or more frames, wherein each of the frames comprises a plurality of power control groups (PCGs);
determine a FL setpoint; and
if a FL setpoint is less than a maximum setpoint value by an amount greater than a predetermined value, autonomously enable discontinuous reception (DRX) to receive a predetermined subset of PCGs among the plurality of PCGs.

16. The computer-readable medium of claim 15, wherein the plurality of PCGs comprises PCG 0 through PCG 15 as defined in CDMA2000 1× standards, and the predetermined subset of PCGs comprise at least one of PCG 10, PCG 11, PCG, 14, or PCG 15.

17. The computer-readable medium of claim 15, wherein for autonomously enabling DRX, the code further causes the AT to blank a receiver path for a predetermined percentage of the time utilized to receive the plurality of PCGs.

18. The computer-readable medium of claim 15, wherein the code further causes the AT to if the FL setpoint is less than the maximum setpoint value by an amount less than the predetermined value, enable receive diversity.

19. The computer-readable medium of claim 15, wherein the code further causes the AT to disable DRX when receive diversity is enabled at the AT.

20. The computer-readable medium of claim 15, wherein for autonomously enabling DRX, the code further causes the AT to:
if the frame is early terminated, blank a receiver path for receiving the remaining PCGs after early termination except the PCGs carrying power control information.

21. The computer-readable medium of claim 20, wherein for blanking the receiver path, the code further causes the AT to power down at least one component of the receiver path during a DRX off period.

22. An apparatus for wireless communication, comprising:
a communication interface configured to receive a forward link (FL) transmission from a network;
a computer-readable medium comprising discontinuous reception (DRX) instructions; and
at least one processor operatively coupled to the communication interface and computer-readable medium,
wherein the at least one processor when configured by executing the DRX instructions, comprises:
a forward link reception block configured to utilize the communication interface to receive a FL transmission comprising one or more frames, wherein each of the frames comprises a plurality of power control groups (PCGs);
a power setpoint block configured to determine a FL setpoint; and
a discontinuous reception (DRX) control block configured to if the FL setpoint is less than a maximum setpoint value by an amount greater than a predetermined value, autonomously enable DRX to receive a predetermined subset of PCGs among the plurality of PCGs.

23. The apparatus of claim 22, wherein the plurality of PCGs comprises PCG 0 through PCG 15 as defined in CDMA200 1× standards, and the predetermined subset of PCGs comprise at least one of PCG 10, PCG 11, PCG, 14, or PCG 15.

24. The apparatus of claim 22, wherein for autonomously enabling DRX, the DRX control block comprises an RX path blanking block configured to blank a receiver path for a predetermined percentage of the time utilized to receive the plurality of PCGs.

25. The apparatus of claim 22, wherein the at least one processor further comprises a receive diversity control block configured to if the FL setpoint is less than the maximum setpoint value by an amount less than the predetermined value, enable receive diversity.

26. The apparatus of claim 22, wherein the at least one processor further comprises a receive diversity control block configured to disable DRX when receive diversity is enabled at the AT.

27. The apparatus of claim 22, wherein for autonomously enabling DRX, the DRX control block is further configured to:
if the frame is early terminated, blank a receiver path for receiving the remaining PCGs after early termination except the PCGs carrying power control information.

28. The apparatus of claim 27, wherein for blanking the receiver path, the DRX control block is further configured to power down at least one component of the receiver path during a DRX off period.
